(19) United States
(12) Patent Application Publication
(10) Pub. No.: US 2025/0060333 A1
(43) Pub. Date: Feb. 20, 2025

(54) DEVICES, METHODS, AND SYSTEMS FOR VISUALIZING ELECTROWETTING PATHING USING ELECTROPHORETIC MATERIALS

(71) Applicant: E INK CORPORATION, Billerica, MA (US)

(72) Inventors: Richard J. PAOLINI, JR., Framingham, MA (US); Brian D. BEAN, Newton, MA (US)

(21) Appl. No.: 18/802,818

(22) Filed: Aug. 13, 2024

Related U.S. Application Data
(60) Provisional application No. 63/532,988, filed on Aug. 16, 2023.

(51) Int. Cl. G01N 27/447; B01L 3/00

(52) U.S. Cl. CPC G01N 27/44721; B01L 3/502784; G01N 27/44786; B01L 2200/025; B01L 2200/0647; B01L 2200/0689; B01L 2300/0645; B01L 2300/161; B01L 2300/1805; B01L 2400/0421; B01L 2400/0427

(57) ABSTRACT

Electrophoretic visualization devices for interfacing with a processing unit configured to drive electrowetting on dielectric (EWoD) digital microfluidic devices. The visualization devices allow a user to visualize droplet pathing in the microfluidic workspace as well as implementation of magnetic fields and heat. Using the visualization devices, a researcher can test pathing protocols, magnetic engagement, and heating without using an actual digital microfluidic device or chemical reagents.

### RELATED APPLICATIONS

This application claims priority to U.S. Provisional Application No. 63/532,988, filed Aug. 16, 2023. All patents and publications disclosed herein are incorporated by reference in their entireties.

### BACKGROUND

Digital microfluidic (DMF) devices use independent electrodes to propel, split, and join droplets in a confined environment, thereby providing a “lab-on-a-chip.” Digital microfluidic devices have been used to actuate a wide range of volumes (nL to μL) and are alternatively referred to as electrowetting on dielectric, or “EWOD,” to further differentiate the method from competing microfluidic systems that rely on electrophoretic flow and/or micropumps. In electrowetting, a continuous or pulsed voltage is applied to an aqueous droplet disposed on a hydrophobic surface, leading to a change in the contact angle at the interface between the droplet surface and the hydrophobic surface. Liquids capable of electrowetting a hydrophobic surface typically include a polar solvent, such as water or an ionic liquid, and often feature ionic species, as is the case for aqueous solutions of electrolytes. A 2012 review of the electrowetting technology was provided by Wheeler in “Digital Microfluidics,” Annu. Rev. Anal. Chem. 2012, 5:413-40. Digital microfluidic techniques allows sample preparation, assays, and synthetic chemistry to be performed with minute quantities of both samples and reagents. Because of the tiny quantities of reagent needed, it is possible to both perform a large number of chemical steps in a small device and/or perform a large number of parallel operations. In recent years, controlled droplet manipulation in microfluidic cells using electrowetting has become commercially viable, and there are now products available from large life science companies, such as Oxford Nanopore.

There are two main architectures of EWoD digital microfluidic devices, i.e., open and closed systems. Typically, both EWOD configurations include a bottom plate featuring a stack of propulsion electrodes, an insulator dielectric layer, and a hydrophobic layer providing a working surface. In addition to the propulsion electrodes, closed systems also feature a top plate parallel to the bottom plate and including a top electrode serving as common counter electrode to all the propulsion electrodes. The top and bottom plates are provided in a spaced relationship defining a microfluidic region to permit droplet motion within the microfluidic region under application of propulsion voltages between the bottom electrode array and the top electrode. A droplet is placed on the working surface, and the electrodes, once actuated, can cause the droplet to deform and wet or de-wet from the surface depending on the applied voltage. When the electrode matrix of the device is being driven, each electrode of the DMF receives a voltage pulse (i.e., a voltage differential between the two electrodes associated with that electrode) or temporal series of voltage pulses (i.e., a “waveform” or “drive sequence” or “driving sequence”) in order to effect a transition from one electrowetting state of the electrode to another.

Many of the literature reports on EWOD involve so-called “segmented” devices, whereby ten to several hundred electrodes are directly driven with a controller. While segmented devices are easy to fabricate, the number of electrodes is limited by space and driving constraints and the devices need to be designed for specific applications. Accordingly, it may prove problematic to perform massive parallel assays, reactions, etc. in segmented devices. In comparison, “active matrix” devices (a.k.a. active matrix EWOD, a.k.a. AM-EWoD) devices can have many thousands, hundreds of thousands or even millions of addressable electrodes and provide a general purpose panel that can be used for many different applications.

The electrodes of an AM-EWOD are typically switched by a transistor matrix, such as thin-film transistors (TFTs), although electro-mechanical switches may also be used. TFT-based thin film electronics may be used to control the addressing of voltage pulses to an EWOD array by using circuit arrangements very similar to those employed in AM display technologies. TFT arrays are highly desirable for this application, due to having thousands of addressable electrodes, thereby allowing mass parallelization of droplet procedures. Driver circuits can be integrated onto the AM-EWOD array substrate, and TFT-based electronics are well suited to the AM-EWOD application.

Because AM-EWOD devices have the ability to simultaneously perform tens, if not hundreds, of reactions simultaneously, it is critical that the movement of the various droplets is choreographed so that the correct reagents are at the proper location at a designated time. Accordingly, AM-EWOD devices employ sophisticated driving protocols such as described in U.S. Patent Publication Nos. 2021/0394190 and 2022/0111387. However, when developing such a protocol, it can be expensive in terms of reagents and EWOD devices to test complicated protocols using liquid reagents. Furthermore, if localized magnetic fields or heat are used during the protocol, it can be difficult to image, e.g., the actuation of a magnet, by observing the AM-EWOD device without using consumables that are costly or may foul the test device preventing it from being used again. An improved method for imaging AM-EWOD protocols is needed. It would be particularly beneficial if the visualization method was completely plug-and-play, allowing for the visualization device to be simply connected to the larger “lab-on-a-chip” system.

### SUMMARY OF INVENTION

In one aspect, the invention includes a visualization device, including (in order as viewed from above): a light transmissive electrode layer, an electrophoretic medium comprising charged particles that translate in response to an applied electric field, an applied magnetic field, or a change in temperature, an adhesive layer, a hydrophobic layer, a dielectric layer, and a substrate comprising a plurality of propulsion electrodes coupled to a set of thin-film-transistors, the propulsion electrodes being disposed on a side of the substrate toward the dielectric layer. In one embodiment, the visualization device additionally includes a controller operatively coupled to the set of thin-film-transistors and configured to provide propulsion voltages to the thin-film transistors. In one embodiment, the hydrophobic layer and the dielectric layer are the same layer. In one embodiment, the electrophoretic medium is compartmentalized in microcapsules held in a binder layer or compartmentalized in microcells sealed with a sealing layer. In one embodiment, the electrophoretic medium comprises two types of charged particles that have different optical properties and opposite electrical charges. In one embodiment, one of the types of charged particles is ferromagnetic. In one embodiment, the ferromagnetic particles are black. In one embodiment of the visualization device, the charged particles are black in color. The invention additionally includes a visualization cartridge including a visualization device of the type described above, wherein the cartridge further includes a connector to allow the visualization cartridge to be connected to a digital microfluidic processing unit configured to drive an active matrix electrowetting on dielectric digital microfluidic (AM-EWOD-DMF) device.

In one aspect, the invention includes a system for visualizing digital microfluidic pathing, including a digital microfluidic processing unit (including a processor and memory, and configured to provide instructions to an active matrix of propulsion electrodes to cause one or more aqueous droplets in a hydrophobic medium to move across the matrix of propulsion electrodes by changing the voltage provided to the respective propulsion electrodes as a function of time), a visualization device comprising a light-transmissive electrode, an electrophoretic medium, and an active matrix of propulsion electrodes controlled by thin-film-transistors, the visualization device being coupled to the digital microfluidic processing unit and configured to receive the instructions, and a camera to observe changes in the visualization device when the instructions are delivered from the digital microfluidic processing unit to the visualization device. In one embodiment, the electrophoretic medium includes two types of electrically-charged particles having different optical states and opposite electric polarities. In one embodiment, one of the types of electrically-charged particles is ferromagnetic. In one embodiment, the system additionally includes a magnetic actuator, wherein the magnetic actuator is also operatively connected to the digital microfluidic processing unit. In one embodiment, the system additionally includes a heating element, wherein the heating element is also operatively connected to the digital microfluidic processing unit. In one embodiment, the visualization device comprises a dielectric layer between the electrophoretic medium and the active matrix of propulsion electrodes controlled by thin-film-transistors. In one embodiment, the visualization device comprises a hydrophobic layer between the electrophoretic medium and the active matrix of propulsion electrodes controlled by thin-film-transistors.

In one aspect, the invention includes a method for visualizing programmed pathing or magnetic actuation in a digital microfluidic device including an array of propulsion electrodes controlled by thin-film-transistors, the method includes providing a digital microfluidic processing unit, including a processor and memory, and configured to provide instructions to an active matrix of propulsion electrodes to cause one or more aqueous droplets in a hydrophobic medium to move across the matrix of propulsion electrodes by changing the voltage provided to the respective propulsion electrodes as a function of time, providing a visualization device comprising a light-transmissive electrode, an electrophoretic medium, and an active matrix of propulsion electrodes controlled by thin-film-transistors, coupling the visualization device to the digital microfluidic processing unit, executing instructions for an active matrix of propulsion electrodes to cause one or more aqueous droplets in a hydrophobic medium to move across the matrix of propulsion electrodes by changing the voltage provided to the respective propulsion electrodes as a function of time and visualizing a change in the visualization device. In one embodiment, visualizing comprises observing optical changes in the electrophoretic medium. In one embodiment, the electrophoretic medium includes two types of electrically-charged particles having different optical states and opposite electric polarities. In one embodiment, one of the types of electrically-charged particles is ferromagnetic. In one embodiment, the method further includes providing a magnetic actuator, wherein the magnetic actuator is also operatively connected to the digital microfluidic processing unit, and executing instructions for the magnetic actuator to move more proximate or less proximate to the visualization device. In one embodiment, the method further includes providing a heating element, wherein the heating element is also operatively connected to the digital microfluidic processing unit, and executing instructions for the heating element to provide thermal energy to the visualization device. In one embodiment, the method further includes providing a detector and aligning the detector to one or more propulsion electrodes. Other modifications of the described invention will be achievable by one of skill in the relevant art, and are also intended to be covered by the disclosure and figures herein.

### BRIEF DESCRIPTION OF DRAWINGS

FIG. 1A is a diagrammatic cross-section of a cell of an example EWOD device. Although the EWOD device of FIG. 1A shows a top electrode (i.e., closed cell), other embodiments may use an open cell design, wherein the top electrode is not present.

FIG. 1B illustrates EWOD operation with a constant voltage top electrode.

FIG. 1C is a schematic diagram of a TFT connected to a gate line, a source line, a propulsion electrode, and a storage capacitor that helps to retain voltage on the propulsion electrode sufficiently long to affect movement of a droplet.

FIG. 2A is a schematic illustration of an exemplary TFT backplane controlling droplet operations in an AM-EWOD propulsion electrode array. An AM-EWOD may potentially have a thousand or more gate lines and a thousand or more source lines, allowing control of millions of propulsion electrodes.

FIG. 2B is a generalized illustration of row-row by row driving, as is typical in a TFT active matrix, which may be the backplane of an AM-EWOD chip or a visualization device.

FIG. 3 illustrates a completed AM-EWOD chip, including a flexible printed circuit connector (FPC) allowing the chip to be connected to driving electronics.

FIG. 4 illustrates an advanced embodiment of an AM-EWOD device whereby magnetic beads can be used to sequester and move target molecules, such as polynucleotides or polypeptides.

FIG. 5 shows an exemplary droplet being driven by a collection of propulsion electrodes.

FIG. 6A illustrates previously-disclosed black and white electrophoretic media, such as used in an eReader.

FIG. 6B illustrates previously-disclosed magnetic black and non-magnetic white electrophoretic media, and the response of such electrophoretic media to a magnet.

FIG. 7 illustrates adding an electrophoretic display layer to an AM-EWOD backplane to produce an exemplary pathway visualization device.

FIG. 8 illustrates adding an electrophoretic display layer including magnetic particles to an AM-EWOD backplane to produce an exemplary pathway visualization device.

FIG. 9 depicts visualization of propulsion electrode pathing.

FIG. 10 depicts visualization of magnetic actuator deployment.

FIG. 11 is an exemplary flow chart for performing a method of the invention.

### DEFINITIONS

Unless otherwise noted, the following terms have the meanings indicated.

“Actuate” or “activate” with reference to one or more electrodes means effecting a change in the electrical state of the one or more electrodes which, in the presence of a droplet, results in a manipulation of the droplet. Activation of an electrode can be accomplished using alternating current (AC) or direct current (DC). Where an AC signal is used, any suitable frequency may be employed.

“Droplet” means a volume of liquid that electrowets a hydrophobic surface and is at least partially bounded by carrier fluid and/or, in some instances, a gas or gaseous mixture such as ambient air. For example, a droplet may be completely surrounded by carrier fluid or may be bounded by carrier fluid and one or more surfaces of an EWOD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWOD device. Droplets may include typical polar fluids such as water, as is the case for aqueous or non-aqueous compositions, or may be mixtures or emulsions including aqueous and non-aqueous components. Droplets may also include dispersions and suspensions, for example magnetic beads in an aqueous solvent. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, and nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes. In further examples, the droplet contents may include reagents for peptide and protein production, for example by chemical synthesis, expression in living organisms such as bacteria or yeast cells or by the use of biological machinery in in vitro systems.

“Droplet area” means the area enclosed within the perimeter of a droplet. In the context of a droplet overlying a pixelated surface (i.e., array of electrodes), the electrodes located within the droplet area are referred to as “droplet electrodes” or “pixel electrodes” or “pixels of the droplet”. When referring to a portion of a droplet, electrodes located within the area of the portion are known as “portion electrodes” or “electrodes of the portion”.

The terms “DMF device”, “EWOD device”, and “Droplet actuator” mean a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. Patent Pub. No. 20060194331, entitled “Apparatuses and Methods for Manipulating Droplets on a Printed Circuit Board,” published on Aug. 31, 2006; Pollack et al., International Patent Pub. No. WO/2007/120241, entitled “Droplet-Based Biochemistry,” published on Oct. 25, 2007; Shenderov, U.S. Pat. No. 6,773,566, entitled “Electrostatic Actuators for Microfluidics and Methods for Using Same,” issued on Aug. 10, 2004; Shenderov, U.S. Pat. No. 6,565,727, entitled “Actuators for Microfluidics Without Moving Parts,” issued on May 20, 2003; Kim et al., U.S. Patent Pub. No. 20030205632, entitled “Electrowetting-driven Micropumping,” published on Nov. 6, 2003; Kim et al., U.S. Patent Pub. No. 20060164490, entitled “Method and Apparatus for Promoting the Complete Transfer of Liquid Drops from a Nozzle,” published on Jul. 27, 2006; Kim et al., U.S. Patent Pub. No. 20070023292, entitled “Small Object Moving on Printed Circuit Board,” published on Feb. 1, 2007; Shah et al., U.S. Patent Pub. No. 20090283407, entitled “Method for Using Magnetic Particles in Droplet Microfluidics,” published on Nov. 19, 2009; Kim et al., U.S. Patent Pub. No. 20100096266, entitled “Method and Apparatus for Real-time Feedback Control of Electrical Manipulation of Droplets on Chip,” published on Apr. 22, 2010; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker et al., U.S. Pat. No. 7,641,779, entitled “Method and Apparatus for Programmable Fluidic Processing,” issued on Jan. 5, 2010; Becker et al., U.S. Pat. No. 6,977,033, entitled “Method and Apparatus for Programmable Fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, U.S. Patent Pub. No. 20110048951, entitled “Digital Microfluidics Based Apparatus for Heat-exchanging Chemical Processes,” published on Mar. 3, 2011; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between Two or Several Solid Substrates,” published on Aug. 18, 2005; and Dhindsa et al., “Virtual Electrowetting Channels: Electronic Liquid Transport with Continuous Channel Functionality,” Lab Chip, 10:832-836 (2010).

“Droplet operation” means any manipulation of one or more droplets on a microfluidic device. A droplet operation may, for example, include: loading a droplet into the DMF device; dispensing one or more droplets from a source reservoir; splitting, separating or dividing a droplet into two or more droplets; moving a droplet from one location to another in any direction; merging or combining two or more droplets into a single droplet; diluting a droplet; mixing a droplet; agitating a droplet; deforming a droplet; holding a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations includes but is not limited to microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Gate driver” is a device directing a drive input for the gate of a transistor such as a TFT coupled to an EWOD electrode electrode. “Source driver” is a device directing a drive input for the source of a transistor. “Top plane common electrode driver” (when used) is a power amplifier producing a drive input for the top plane electrode of an EWOD device.

“Drive sequence” or “pulse sequence” denotes the entire voltage against time curve used to actuate an electrode in a microfluidic device. Typically, as illustrated below, such a sequence will comprise a plurality of elements; where these elements are essentially rectangular (i.e., where a given element comprises application of a constant voltage for a period of time), the elements may be called “voltage pulses” or “drive pulses”. The term “drive scheme” denotes a set of one or more drive sequences sufficient to effect one or more manipulations on one or more droplets in the course of a given droplet operation. Unless stated otherwise, the term “frame” denotes a single update of all the electrode rows in a microfluidic device.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix, or surface, such liquid could be either in direct contact with the electrode/array/matrix/surface, or could be in contact with one or more layers or films that are interposed between the liquid and the electrode/array/matrix/surface.

When a droplet is described as being “in”, “on”, or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

“Each,” when used in reference to a plurality of items, is intended to identify an individual item in the collection but does not necessarily refer to every item in the collection. Exceptions can occur if explicit disclosure or context clearly dictates otherwise.

### DETAILED DESCRIPTION

The inventions described herein relate to devices, methods, and systems for visualizing (either with the human eye, a camera, or detector) the pathing of propulsion electrodes, magnets, or heaters that are used with digital microfluidic (a.k.a. “lab-on-a-chip”) platforms. In some instances, multiple different simultaneous operations, i.e., pathing and magnetic actuation can be visualized. The visualization devices use electrophoretic particles of the type commonly associated with reflective displays, and the visualization is reversible, so that the visualization devices can be reused. Thus, the inventions provide drop-in solutions that allow researchers to verify that the correct operations have been programmed into the various controllers of an EWoD-DMF system (e.g., droplet driving controller, magnetic actuator controller, heat controller) without the need to use an actual EWOD cartridge and reagents. Because the pathing/actuations can be visualized before the protocols are implemented, researchers are able to correct errors in programming before risking expensive reagents or precious samples. Visualization devices are also useful during initial installation, calibration, optical alignment of detection equipment, and troubleshooting.

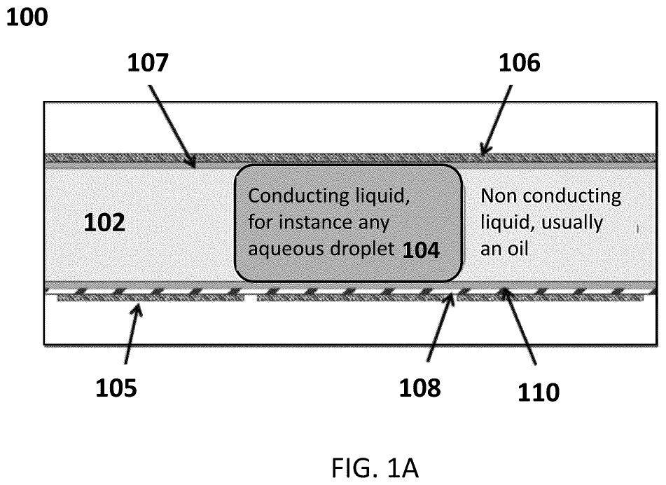

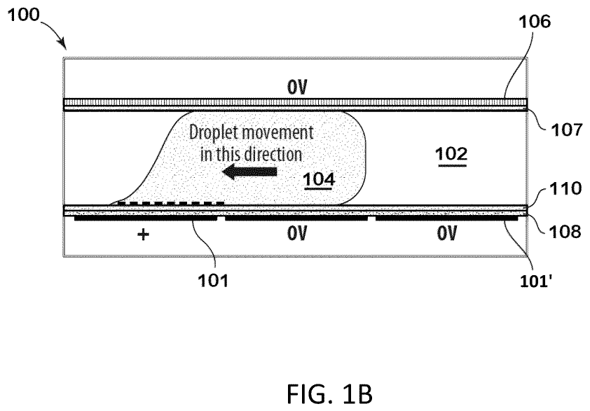

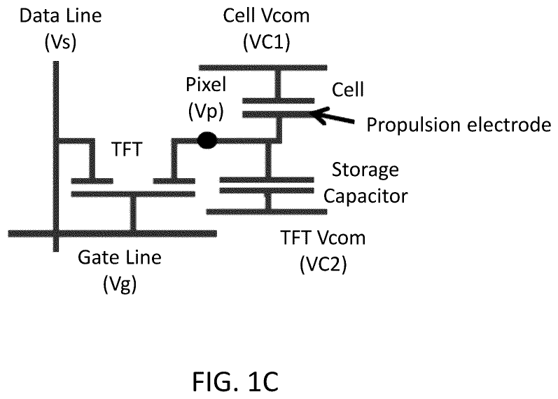

FIG. 1A shows a diagrammatic cross-section of an electrowetting “cell” of a closed EWOD device where droplet 104 is surrounded on the sides by carrier fluid 102 and sandwiched between top hydrophobic layer 107 and bottom hydrophobic layer 110. A top electrode 106 is disposed above the top hydrophobic layer 107. Propulsion electrodes 105 can be directly driven or switched by transistor arrays arranged to be driven with data (source) and gate (select) lines, much like an active matrix in liquid crystal displays (LCDs), resulting in what is known as active matrix (AM) EWOD. Typically, a dielectric layer 108 is disposed between the propulsion electrodes 105 and the bottom hydrophobic layer 110 to protect the propulsion electrodes 105 from electrochemical reaction and shorts between neighboring propulsion electrodes 105. The spacing between top electrode 106 and the propulsion electrodes (and accordingly the approximate cell spacing) is usually in the range of about 20 μm to about 500 μm. The bottom hydrophobic layer 110 and the dielectric layer 108 are typically two separate materials, stacked as two separate layers, however in some instances a single layer, such as PTFE, may be suitable as both a dielectric layer and a hydrophobic layer. In some embodiments, an additional barrier layer, such as an organic barrier layer (not shown in figures) maybe disposed between the dielectric layer 108 and the bottom hydrophobic layer 110.

The nature of the dielectric layer 108 is not crucial to the instant application however, the type of dielectric layer 108 may influence the speed and durability of the resulting AM-EWOD, as discussed in greater detail in U.S. Pat. No. 11,675,244. In some embodiments, dielectric layer 108 is between 10 nm thick and 300 nm thick, i.e., between 25 nm thick and 150 nm thick. The dielectric layer 108 may comprise silicon oxide, aluminum oxide, hafnium oxide, tantalum oxide, or silicon nitride, and the dielectric layer may be formed by a combination of both atomic layer deposition and sputtering. Similarly, the nature of the top hydrophobic layer 107 and the bottom hydrophobic layer 110 is not crucial to the instant application, however more commonly-used hydrophobic layer materials are fluoropolymers, which can be between 10 and 50 nm thick, and deposited with spin-coating or another coating method. Specific suitable hydrophobic materials include TEFLON-PTFE (poly-tetrafluoroethylene), TEFLON-AF (amorphous polytetrafluoroethylene copolymer), CYTOP (poly(perfluoro-butenylvinyl ether), or FLUOROPEL (perfluoroalkyl copolymers). Other, newer, hydrophobic coatings may also be used, such as described in U.S. Pat. No. 9,714,463.

A common driving mode of a digital microfluidic cell is to keep the voltage on the top electrode 106 constant while actuating the propulsion electrodes, as shown in FIG. 1B. The potential may be, for example, zero volts. As a result, the potential applied across the cell is the voltage on a first activated propulsion electrode 101, having a different voltage to the top electrode 106 so that conductive droplets are attracted to the electrode. Meanwhile, a second non-activated propulsion electrode 101′ has the same voltage as the top electrode 106, which could be, e.g., zero volts. In active matrix TFT devices, when the top electrode is held at ground potential the total voltage on the cell is limited to electrode driving voltages, i.e., about ±15 V, because in commonly used amorphous silicon (a-Si) TFTs the maximum voltage is in the range from about 15 V to about 20 V due to TFT electrical instabilities under high voltage operation. Higher voltages are possible if the transistors are constructed from metal oxide materials such as IGZO, and such materials are becoming more readily available for such applications.

Amorphous silicon TFT plates usually have only one transistor per electrode, although configurations having two or more transistors are also contemplated. As illustrated in in FIG. 1C, the transistor is connected to a gate line, a source line (also known as “data line”), and a propulsion electrode. When there is large enough positive voltage on the TFT gate then there is low impedance between the source line and electrode (Vg “ON”), so the voltage on the source line is transferred to the propulsion electrode. When there is a negative voltage on the TFT gate then the TFT is high impedance and voltage is stored on the electrode storage capacitor and not affected by the voltage on the source line as the other electrodes are addressed (Vg “OFF”). If no movement is needed, or if a droplet is meant to move away from a propulsion electrode, then 0 V, that is, no voltage differential relative to the top plate, is present on the pixel electrode. Ideally, the TFT should act as a digital switch. In practice, there is still a certain amount of resistance when the TFT is in the “ON” setting, so the electrode takes time to charge. Additionally, voltage can leak from Vs to Vp when the TFT is in the “OFF” setting, causing cross-talk. Increasing the capacitance of the storage capacitor Cₛ reduces cross-talk and increases the “push” when a voltage is presented to a droplet, but at the cost of rendering the electrodes harder to charge and taking longer to complete a full row-after-row scan of all of the propulsion electrodes.

The drivers of a TFT array receive instructions relating to droplet operations from a digital microfluidic processing unit. The processing unit may be, for example, a general purpose computer, special purpose computer, personal computer, or other programmable data processing apparatus providing processing capabilities, such as storing, interpreting, and/or executing software instructions, as well as controlling the overall operation of the device. The processing unit is coupled to a memory which includes programmable instructions to direct the processing unit to perform various operations, such as, but not limited to, providing the TFT drivers with input instructions directing them to generate electrode drive signals in accordance with embodiments herein. The memory may be physically located in the DMF device or in a computer or computer system which is interfaced to the device and hold programs and data that are part of a working set of one or more tasks being performed by the device. For example, the memory may store programmable instructions to carry out the drive schemes described in connection with a set of droplet operations. The processing unit executes the programmable instructions to generate control inputs that are delivered to the drivers to implement one or more drive schemes associated with a given droplet operation. The processing unit may also be programmed to activate, e.g., pumps or dispensers to add/remove reagents/waste from the work area. Additionally, when appropriate for the protocol the processing unit may be programed to bring one or more magnets adjacent the EWOD backplane in order to retain magnetic particles, such as magnetic silica particles. In other instances the processing unit may activate one or more heaters or coolers (e.g., resistive heaters, Peltier coolers) to increase or decrease the ambient temperature of a portion of the EWOD device.

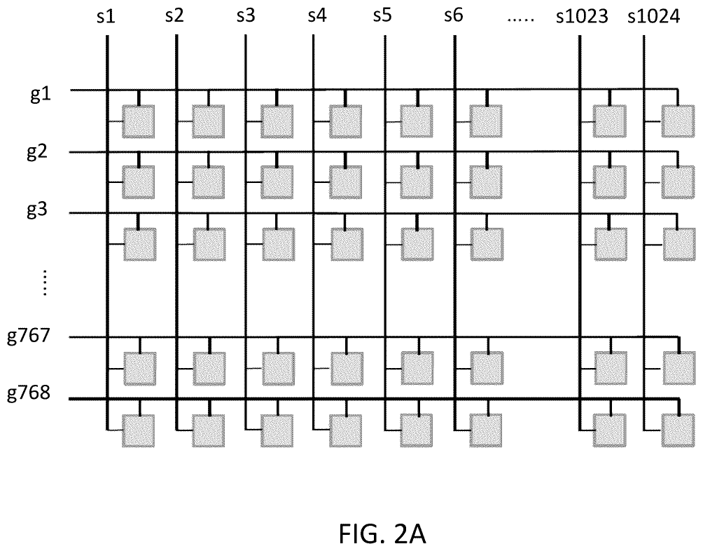

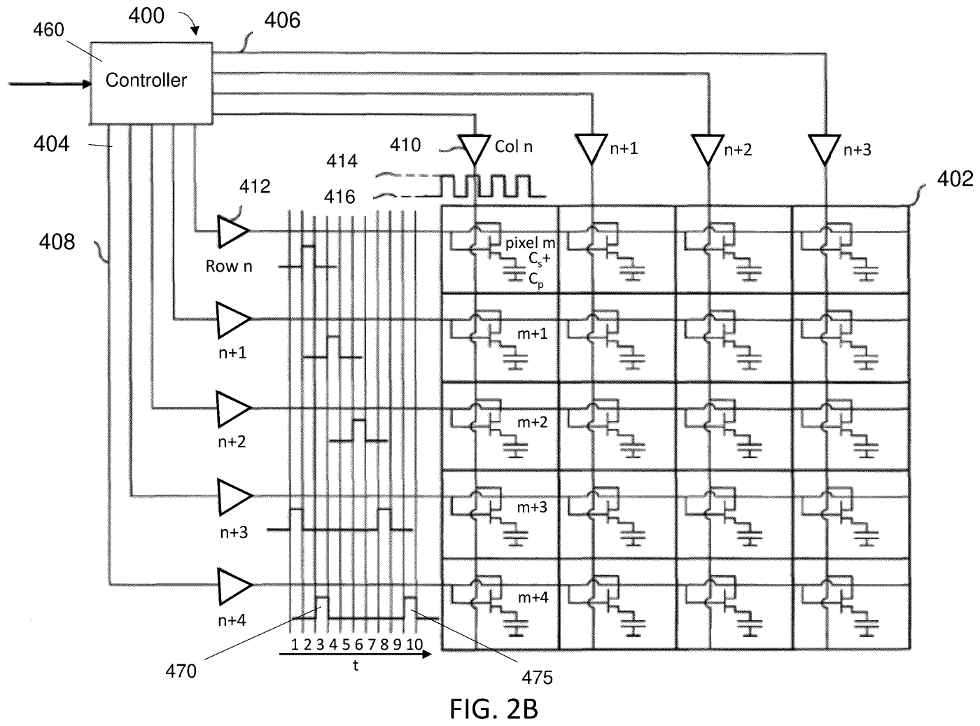

FIG. 2A is a diagrammatic view of an exemplary TFT backplane controlling droplet operations in an AM-EWOD propulsion electrode array. In this configuration, the elements of the EWOD device are arranged in the form of a matrix as defined by the source lines and the gate lines of the TFT array. The source line drivers provide the source levels corresponding to a droplet operation. The gate line drivers provide the signals for opening the transistor gates of electrodes which are to be actuated in the course of the operation. The gate line drivers may be integrated in a single integrated circuit. Similarly, the data line drivers may be integrated in a single integrated circuit. The driving gate line-scan line driving overlap, as well as the row-by-row updating is illustrated in FIG. 2B.

As shown in FIG. 2B, an addressing or propulsion electrode, which addresses one pixel electrode, is fabricated on a substrate 402 and connected to the appropriate voltage sources 404 and 406 through the associated non-linear element. It is understood that the voltage sources 404 and 406 may originate from separate circuit elements or the voltages can be delivered with the assistance of a single power supply and a power management integrated circuit (PMIC). In some instances an intervening source controller is used to control the supplied voltage, however in other embodiments the controller 460 is configured to control the entire addressing process, including coordinating the gate and source lines. It is also to be understood that FIG. 2B is an illustration of the layout of an active matrix backplane 400 but that, in reality, the active matrix has depth and some elements, e.g., the TFT, may actually be underneath the propulsion electrodes, with a via providing an electrical connection from the drain to the pixel electrode above. In high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are typically connected to a row driver (gate driver, gate controller), which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are typically connected to column drivers (source driver, source controller), which place upon the various column electrodes voltages selected to drive the pixels in the selected row to their desired optical states. (The aforementioned voltages are with respect to a common front electrode which is conventionally provided on the opposed side of the electro-optic medium from the non-linear array and extends across the whole display.) After a pre-selected interval known as the “line address time” the selected row is deselected, the next row is selected, and the voltages on the column drivers are changed so that the next line of the display is written. This process is repeated so that the entire display is written in a row-by-row manner. The time between addressing in the display is known as a “frame.” Thus, a display that is updated at 60 Hz has frames that are 16 msec. A display that is updated at 85 Hz has frames that are 12 msec. A display that is updated at 120 Hz has frames that are 8 msec.

The integrated circuit may include the complete gate and source driver assemblies together with a controller. Commercially available controller/driver chips include those commercialized by Ultrachip Inc. (San Jose, California), such as UC8152, a 480-channel gate/source programmable driver. In the example of FIG. 2A, the propulsion electrode matrix is made of 1024 source lines and a total of 768 gate lines, although either number may change to suit the size and spatial resolution of a particular EWOD DMF device. In the embodiment of FIG. 2A, each element of the matrix could contain a TFT of the type illustrated in FIG. 1C for controlling the potential of a corresponding pixel electrode, and each TFT could be connected to one of the gate lines and one of the source lines. The rate at which all of the members of the active matrix receive instructions in a row-by-row fashion is known as a “frame” and a frame rate of 100 Hz may be taken for an example in estimating line times. Displays often have about one thousand gate lines. Accordingly a frame rate 100 Hz results in a frame time of 10 ms, and one thousand gate lines result in a maximum line time available of 10 ms/1000=10 μs. For TFT array operations, approximately 8 to 10 μs MLT are needed for charging electrodes. The exact details of time needed are strongly influenced by gate and source line RC time constants, which depend on array design and display size. Additionally, for an EWoD device 100 of the type of discussed above, the RC time constant is also influenced by the composition and thickness of the dielectric layer 108 and the hydrophobic layer 110.

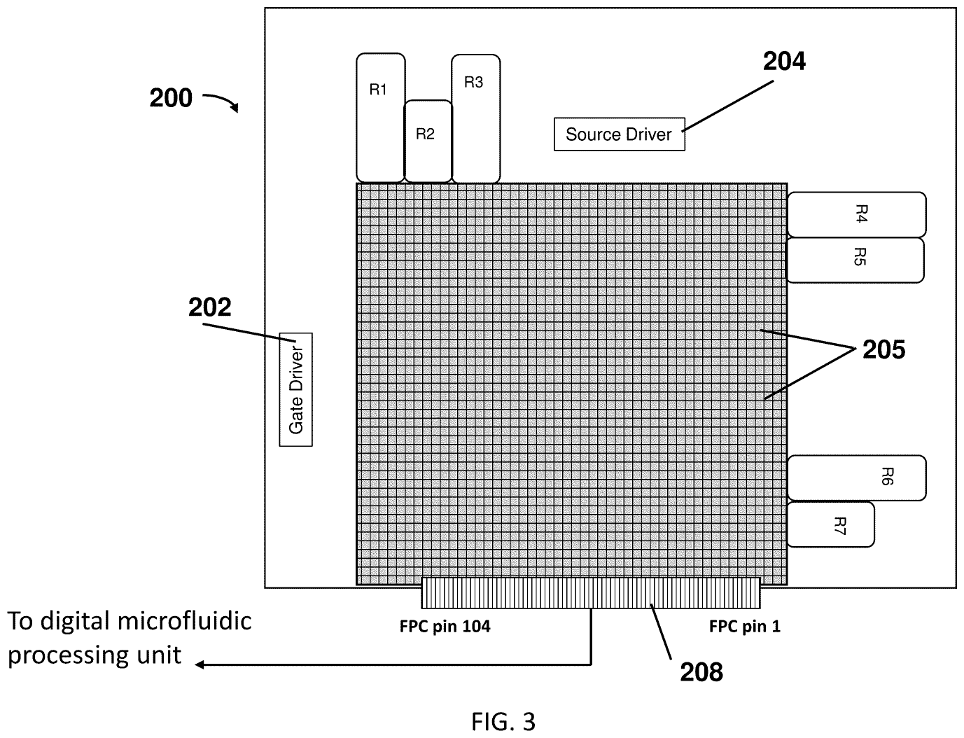

A typical commercial embodiment of an AM-EWOD cartridge and control system is shown in FIG. 3. As discussed above, the general architecture of an EWOD cartridge (generally designated 200) includes an active matrix of propulsion electrodes 205. A series of seals and spacers provide a microfluidic workspace between the propulsion electrodes and the top electrode, as discussed above. In many instances, reservoirs R1-R7 are arranged around the periphery of the propulsion electrodes 205. The reservoirs R1-R7 are configured to introduce droplets into the microfluidic workspace or to remove wastes from the microfluidic workspace. While not shown here, the reservoirs may be coupled to dispensers (tubes, syringes) that provide additional volumes of reagents to the reservoirs R1-R7. Depending upon the intended application of the EWOD device, the reservoirs R1-R7 may contain biological specimens (for example body fluids), reagents, raw materials, catalysts, solvents and cosolvents or any other materials required for the chemical reactions or tests to be conducted by the device. In FIG. 3, reservoirs R1-R7 are shown arranged in three groups along two different edges of the matrix of electrodes 205 but this is purely for purposes of illustration and the number of reservoirs, their grouping and their placements may be varied as desired.

In some instances, the cartridge 200 further comprises a gate (or row) driver 202 and a source (or data) driver 204, both of which function in a manner similar to the corresponding drivers of an active matrix electro-optic display, as discussed below with reference to FIG. 2A. (The connections between the drivers 202 and 204 and the propulsion electrodes 205 are omitted from FIG. 3 for ease of illustration.) In some embodiments, however, the gate driver 202 and the source driver 204 are “off-chip” meaning that the gate driver 202 and the source driver 204 are not part of the cartridge 200. Regardless of whether the gate driver 202 and the source driver 204 are part of the cartridge 200, the cartridge 200 typically includes a connector 208 which provides signal communication between the processing unit (including for example a controller, a processor, memory, etc., as discussed above) and the cartridge 200. The connector 208 also allows the cartridge 200 to be decoupled from the processing unit, and a different cartridge 200′ to be coupled to the same processing unit. In addition to signals, the FPC also provides a pathway for power, e.g., voltage levels such as +/−15V and 0V, as will be applied to the top and bottom electrodes 106 and 105. The connector 208 may be a flexible printed circuit (FPC) connector or a flat flexible cable (FFC) connector, both of which are commonly found on similar backplanes/display modules when used for e.g., an LCD display or an electrophoretic (EPD) display. In particular, the presence of the connector 208 allows a singular processing unit to be used for many different cartridges 200, thereby allowing cartridges 200 to be swapped out without the need to make additional modifications to the setup. Typically a flexible ribbon of wires interfaces between the cartridge 200 and the processing unit. Furthermore, the cartridge 200 can be disconnected from the processing unit and a visualization device of the invention (see below) can be connected to allow visualization/troubleshooting of the set up.

An AM-EWOD DMF system may include a number of additional analytical tools as needed for various assays or reactions. For example, in some embodiments a sample droplet will be assayed for the presence (optionally the concentration) of an analyte. The sample may be diluted by combination with one or more droplets of a solvent, and the dilution step may be repeated until a desired analyte concentration range is attained. Then, a droplet of the diluted sample is mixed with droplet(s) of one or more reactants that form a detectable, quantifiable assay product with the analyte. Thereafter, the sample droplets may be evaluated to detect and measuring the concentration of the assay product. Example detection and measuring techniques include spectrophotometry in the visible, UV, and IR ranges, time-resolved spectroscopy, fluorescence spectroscopy, Raman spectroscopy, phosphorescence spectroscopy, and potentiodynamic electrochemical measurements such as cyclic voltammetry (CV), all of which may be incorporated into the system. In instances where the analyte is a diagnostic biomarker, for example a protein associated with a given disease or disorder, the sample droplet may be mixed with a droplet of a solution containing an antibody directed against the protein to be measured. In an enzyme-linked immunosorbent assay (ELISA), the antibody is linked to an enzyme, and another droplet, this time of a substance containing the enzyme's substrate, is added. The subsequent reaction produces a detectable signal, most commonly a color change that may be detected and measured. In order to facilitate spectroscopic analysis (including color measurement), the top electrode is constructed from materials that are radiation-transmissive, i.e., indium tin oxide. Obviously, the radiation transmissive properties of the top electrode need to be chosen having regard to the wavelengths at which the spectroscopic analysis is to be conducted. In addition, AM-EWOD DMF systems often include an optical camera, which may use one or more magnifying lenses to allow real time observation and recording of the motion of the droplets on the array of propulsion electrodes. This same optical camera can be used to visualize the pathing programs when coupled to a visualization device of the invention.

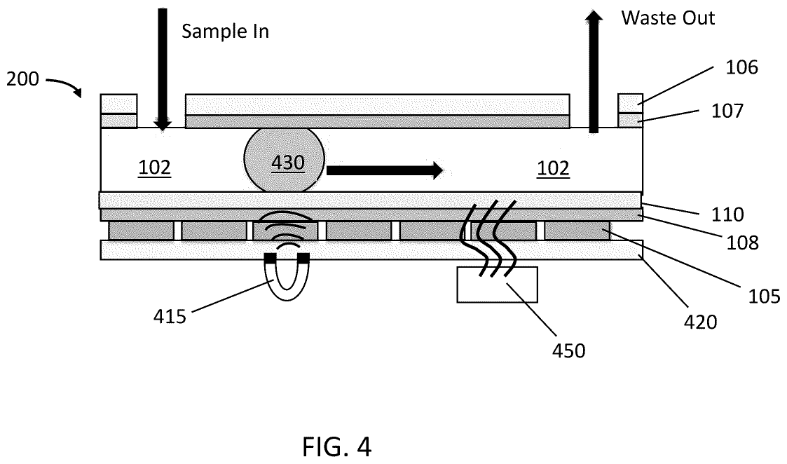

In some embodiments, a magnetic actuator 415 may be added to cartridge 200, as shown in FIG. 4. Again, the cartridge 200 includes an array of propulsion electrodes 105 disposed on substrate 420 and a singular top electrode 106 disposed on the opposing surface. The device additionally includes top and bottom hydrophobic layers, 107 and 110, forming working surfaces in contact with the carrier fluid layer 102, as well as a dielectric layer 108 between the propulsion electrodes 105 and bottom hydrophobic layer 110. As shown in FIG. 4, one or more magnetic beads 430 are included in the working space, and the magnetic beads 430 can be retained and moved by a magnetic actuator 415. Commonly, the magnetic beads are silica-coated magnetic materials, wherein the silica has been functionalized with ligands specific for an analyte or nucleic acid sequence, etc. Such magnetic beads can be purchased directly from suppliers such as Promega Corporation (Madison, WI), IBA Lifesciences (Göttingen, Germany), Cytiva (Marlborough, MA) and ThermoFisher Scientific (Watham, MA). In addition, as shown in FIG. 4, a heating element 450 may also be used to provide thermal energy to the microfluidic workspace, leading to an increase in temperature of the carrier fluid layer 102 and any droplets 104 in the vicinity. Both the magnetic actuator 415 and the heating element 450 may be used simultaneously or separately. In advanced AM-EWOD systems, the processing unit can be configured to move droplets 104 with the propulsion electrodes 105 and at the same time implement magnetic fields and heat, as needed to accomplish a protocol.

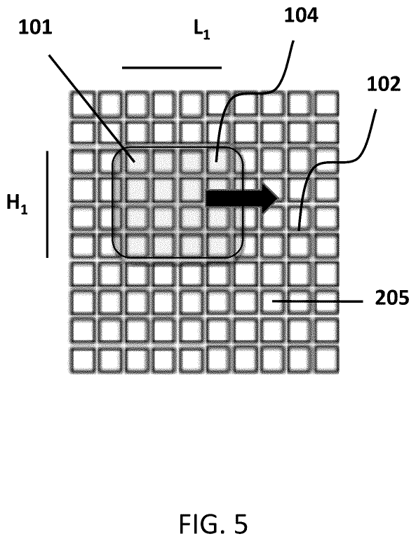

When the active matrix of propulsion electrodes 205 is viewed from above, and assuming that the droplet 104 and carrier fluid 102 are not identical in color, the droplet 104 can be seen to move across the microfluidic workspace, as illustrated in FIG. 5. Accordingly, it is possible to visualize the movement of droplets in order to evaluate whether a programmed protocol has been programmed correctly. However, and important to the invention, doing so requires that a prepared AM-EWOD cartridge 200 (FIG. 3) is used, which may result in contamination when the cartridge actually used for assays/experiments. Furthermore, without magnetic beads 430 or some other magnetic structure in the fluidic workspace, it is nearly impossible to visualize the position of the magnetic actuator 415 when viewing the matrix of propulsion electrodes 205 from above, i.e., through the top electrode layer 106. It is also difficult to discern magnetic strength in the event that different types of magnetic actuators 415 are used (i.e., having inherently stronger or weaker magnetism). Additionally, electromagnetics may be used to provide finer control of magnetic fields to retain or move magnetic beads, or the magnetic actuator 415 may have three dimensions of mechanical control so that the field experienced by the fluidic work space can be increased by moving the magnetic actuator 415 closer to the AM-EWOD device. Similarly, it is difficult to visualize where heat is being added with heating element 450. Using the devices, methods, and systems of the invention, visualizing activated propulsion electrodes, magnetic fields, and temperature differentials is much easier, resulting in faster protocol development as well as less waste.

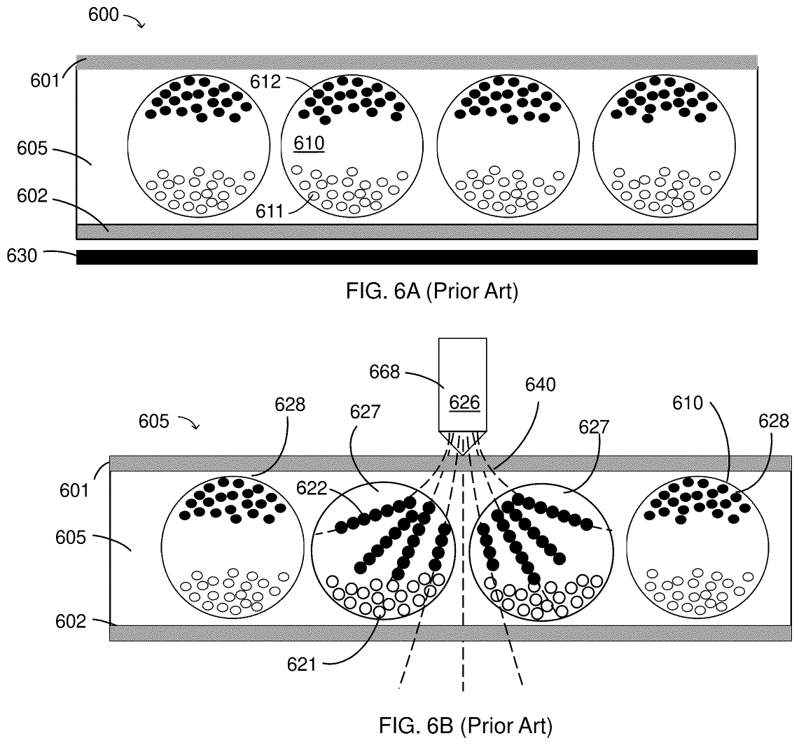

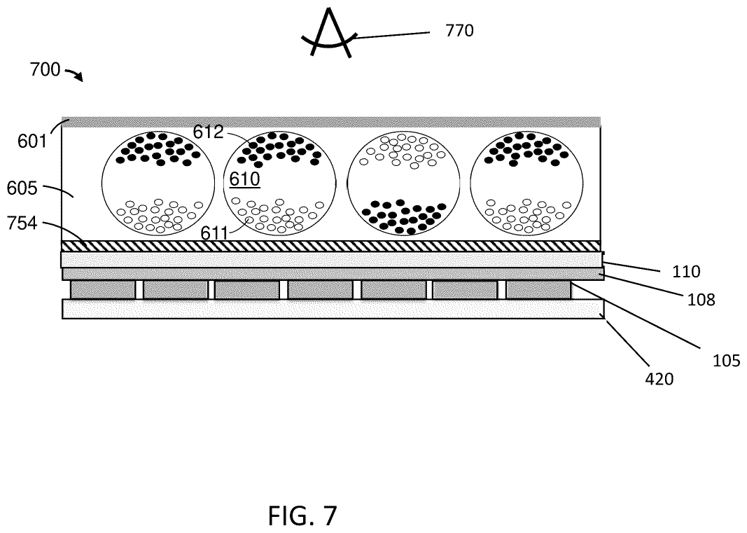

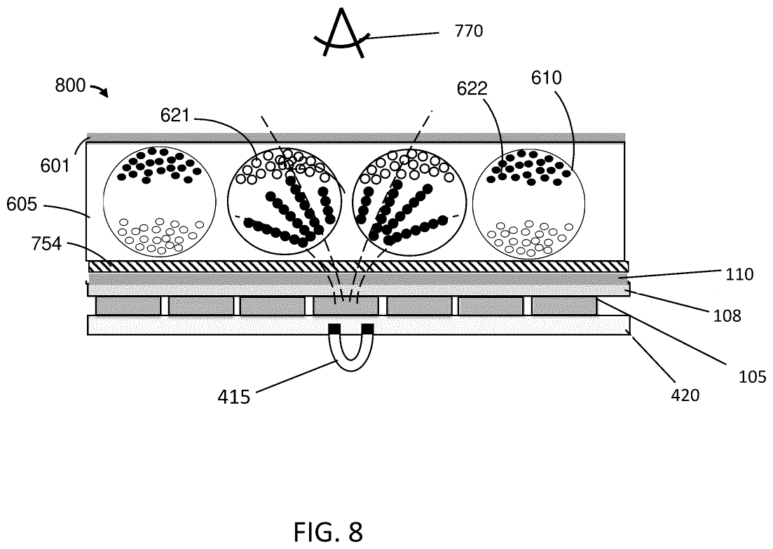

The general principles of electrophoretic media, including non-magnetic and magnetic are illustrated in FIGS. 6A and 6B. FIG. 6A depicts a “standard” oppositely-charged-particle electrophoretic display layer. Display 600 includes front and back electrodes 601 and 602, respectively. The front electrode 601 is light-transmissive while the back electrode 602 can be a solid electrode, a segmented electrode, an active matrix of pixel electrodes, and optionally light-transmissive. The front electrode 601 is typically formed from a transparent conductive polymeric medium such as PET-ITO or PEDOT, however alternative light-transmissive polymers (polyesters, polyurethanes, polystyrene) doped with conductive additives (metals, nanoparticles, fullerenes, graphene, salts, conductive monomers) are also suitable for use. The back electrode 602 may comprise any of the components listed for the front electrode 601, however the back electrode can also be a metal foil, a graphite electrode, or some other conductive material. A segmented or TFT backplane can be also be used instead of the back electrode 602 to add more versatility in displaying printed and graphic information. In many embodiments, both the front and back electrodes 601 and 602, respectively, are flexible, thus the entire display 600 is also flexible. The display 600 is often supported by a substrate 630, which may also be light-transmissive and/or flexible. While not shown in FIGS. 6A and 6B, it is understood that that one or more adhesive layers are included in the construction in order to facilitate roll-to-roll processing as well structural integrity. Furthermore a binder 605 is used to fill the gaps between microcapsules 610. The display 600 may additionally include a top protective sheet (not shown) to protect the front electrode 601 from being damaged by a stylus or other mechanical interaction. Filter layers (not shown) to change color (i.e., a CFA) or to protect the medium from UV exposure may also be included. While not shown in FIG. 6A, it is understood that a front plane laminate (FPL) may be constructed whereby the back electrode 602 and back substrate 630 may replaced with an adhesive layer 754 (shown in FIGS. 7 and 8) and a release sheet (not shown). (Such FPL is typically quite flexible and can be rolled for storage and shipment.) Accordingly, the release sheet can be removed, and the combined top electrode and electrophoretic layer can be laminated directly to a back electrode layer 602, which may be an active matrix backplane. The resulting device is display 600.

The display layer of FIGS. 6A and 6B include a plurality of containers to segregate portions of the electrophoretic medium. In the instance of FIGS. 6A and 6B, the containers are microcapsules 610 dispersed in a binder 605, and within the microcapsules 610 are liquid medium and one or more types of colored pigment particles, wherein at least one type of particle is magnetically-responsive. As shown in FIG. 6A, this includes white pigment particles 611 and black pigment particles 612. Typically, the white pigment particles 611 and black pigment particles 612 are oppositely (electrically) charged such that when one polarity of electric field is presented between the front 601 and back 602 electrodes one of the two particles will present at that the front electrode 601 (aka viewing surface) and when the polarity of the electric field is reversed, the other particle will present at the front electrode 601. Furthermore, one or both of pigments 611 and 612 may move within, or otherwise respond to, a magnetic field. For example, one or both types of pigment particles may align along magnetic field lines, and/or may form chains of particles (see FIG. 6B). In such instances, the pigment particles 611 and/or 612 may be controlled (displaced) with an electric field (e.g., produced by electrodes 601-602), thus making the display 600 operate as an electrophoretic display when addressed. In addition, as depicted in FIG. 6B, the black pigment particles 612 are magnetically-responsive. It is understood that the capsules 610 could be replaced with microcells or polymer-dispersed droplets, as known in the art.

In addition to being sensitive to electric fields, it is known that electrophoretic display materials of the type described above are temperature-sensitive. The temperature sensitivity results from changes in the viscosity of the internal phase (i.e., the pigments+solvent+charge control agents+dispersed polymers) as well as changes in the conductivity of the adhesive layers between the top and bottom electrodes and the electrophoretic media. In particular, if a subthreshold electric field (i.e., not sufficient to cause one set of particles to move to the viewing surface) is present between the electrodes, and the temperature of the electrophoretic medium is increased, the particles will begin to move and an optical change is viewable in the display. This phenomenon is detailed in U.S. Patent Publication No. 2004/0105036 and U.S. Pat. No. 7,859,513. Thus, under the correct conditions an electrophoretic film can be used to detect temperature changes. Furthermore, if multiple types of pigments are present the effects of the temperature change can be more easily visualized. Instead of changing from white to gray, a multi-pigment system may turn from cyan to magenta.

As shown in FIG. 6B, the display 200 may comprise only a single type of magneto-electrophoretic particle 622, i.e., using the materials described in U.S. Pat. No. 11,221,685, for example, black ferromagnetic materials from Lanxess (Bayferrox 318M; Lanxess, Pittsburgh, PA). Accordingly, when presented with a magnetic field, the magneto-electrophoretic particles 622 chain, which actually makes the white particles 621 more visible as compared to the portions of the electrophoretic medium that do not experience the magnetic field. To illustrate the phenomenon, FIG. 6B depicts a stylus 668 causing a change in an optical state of a display 605. In the example of FIG. 6B, the stylus 668 produces a magnetic field 626 depicted in part by field lines 640 that cause black pigment particles 622 to form chains. Due to the shape and structure of the chains of black pigment particles, light entering display 605 from the viewing side (i.e., via top electrode 601) may largely pass by black pigment chains 622 and be reflected from the white pigment particles 621. Accordingly, in the configuration shown in FIG. 6B, capsules 627 will appear white (i.e., light gray), whereas capsules 628 will appear black (i.e., dark gray), on the viewing side of the display 605. Accordingly, where a stylus 668 causes chaining of pigment particles 622, such as in capsules 627, a facsimile of a drawn image representing the motion of the stylus 668 will be visible at the viewing surface of the display 605. This same principle can be used to image the position and motion of the magnetic actuator 415 of FIG. 4, as will be explained below.

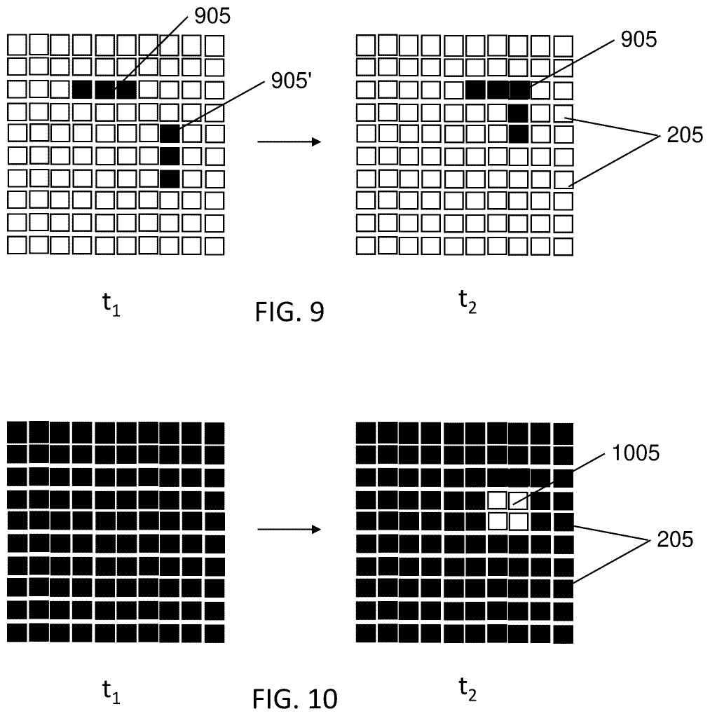

By leveraging the response of electrophoretic media to changes in electric fields, magnetic fields and heat, a device for visualizing electrowetting pathing, including droplet movement, magnetics, and heat can be realized as shown in FIGS. 7 and 8. The electrophoretic portion of a visualization devices 700, 800 includes microcapsules 610 dispersed in a binder 605, and within the microcapsules 610 are liquid medium and one or more types of colored pigment particles, wherein optionally one type of particle is magnetically-responsive. As shown in FIG. 7, this includes white pigment particles 611 and black pigment particles 612. As shown in FIG. 9, this includes white non-magnetic pigment particles 621 and black magnetic pigment particles 622. The top electrode 601 is typically a light-transmissive electrode film, such as PET-ITO. The incorporation of an adhesive layer 754 allows the electrophoretic layer to be coupled directly to the hydrophobic layer 110 of an EWOD backplane, i.e., as described above. A variety of adhesive materials can be used with a visualization devices 700, 800, such as polyurethanes, especially polyurethanes and urethane acrylates doped with conductive moieties, i.e., as described in U.S. Pat. No. 9,777,201. Importantly, the visualization devices 700 and 800 differ from prior art electrophoretic displays 600 and 605 in that they include both a dielectric layer 108 and a hydrophobic layer 110, which is normally not required in a corresponding electrophoretic display. In fact, it is well-known that including a dielectric layer in an electrophoretic display typically results in charge build-up on the pixel electrodes which results in “kick-back” or image drift with time as the built up charges discharge. Nonetheless, the electric field response of an electrowetting propulsion electrode 105 is a tied to the material stack between the propulsion electrodes 105 and a top electrode 106 (if present), thus it is important to include the dielectric layer 108 and the hydrophobic layer 110 so that the timing of the switching of the propulsion electrodes 105 can be accurately reproduced with the electrophoretic display material. In many instances, if an electrowetting drive protocol were provided directly to an unmodified electrophoretic display 600, 605, the observed drive timing would be off because the display pixels end up being charged less than the corresponding propulsion electrodes. In some instances, the frames rates will be shorter without the dielectric layer 108 and the hydrophobic layer 110 so that if the “motion” of electrophoretic pixels is visualized and correlated with the approach of the magnetic actuator 415, the timing may be off such that the magnetic fields and the droplet motion are not properly synchronized in an actual AM-EWOD DMF device.

While not shown specifically in the figures, a visualization device 700, 800 can be incorporated into a visualization cartridge, which is roughly identical to the cartridge 200 of FIG. 3, however an intervening electrophoretic display layer (magnetic or non-magnetic) is affixed to the array of propulsion electrodes 205. (A visualization cartridge may or may not include reservoirs, but reservoirs are generally not required for visualization.) Such a visualization cartridge will have an identical connector 208 as the cartridge of FIG. 3, however a top electrode 601 connection will be provided so that the correct bias can be applied to the top electrode 601 via the processing unit, similar to an EWOD device having a top electrode 106. A visualization cartridge will thus allow a researcher to confirm pathing for an experiment and then swap out the visualization cartridge with the EWOD DMF cartridge in order to run an experimental protocol.

A system including a visualization device 700, 800, may include a camera 770, which may use additional optical lenses, such as a microscope objective, to better visualize the position of the propulsion electrodes 105 that are being activated. The images recorded by the camera 770 may be further processed with image tracking software to confirm that the processing unit is properly programmed before an protocol is performed with live EWoD cartridges and actual samples/reagents. A system may additionally include a calibrated light source, a spectrophotometer, one or more photo diodes, a CCD camera, or a calibrated comparison sample. Illustrations showing the activation of visualization devices 700 and 800 when driven with EWoD pathing protocols are shown in FIGS. 9 and 10, respectively. In FIG. 9 at an arbitrary first time (t₁), a number of activated propulsion electrodes 905 can be visualized as contrasting colored pixels. (While FIG. 9 shows driving a white field to black, the reverse color scheme is also possible, as well as a multi-color system including more than two types of electrophoretic particles.) At some later time (t₂) the location of the pixels that have been activated has changed. If the same drive scheme was delivered to an EWOD device, the change in activated propulsion electrodes would result in transportation of one or more droplets. Additionally, as shown in FIG. 9 it is possible to visualize bringing together two droplets. In the event that the visualization device showed that activated pixels 905 did not “touch” activated pixels 905′ at the second time, adjustments could be made in the pathing protocol. As shown in FIG. 10, it is additionally possible to visualize delivery of magnetic fields or heat. In FIG. 10, at a first time (t₁) a visualization device 800 does not show the presence of a magnetic field, thus all of the pixels are the same color. Once a magnetic actuator 415 is engaged at a later time (t₂), the magnetic fields cause an optical change at the propulsion electrodes exposed to magnetic fields 1005. In a similar fashion, it is possible to visualize the delivery of heat, i.e., with a heating element 450 as described above. It is possible to simultaneously visualize driving and magnetic engagement and heat application, however, it is likely necessary to modify the driving protocol to insert clearing pulses so that chained magnetic particles can be re-distributed after the magnetic actuator 415 is moved away from the visualization device 800. Typically, the magnetic actuator(s) 415 are coupled to a stage or platform holding a digital microfluidic cartridge, and are not part of the visualization device.

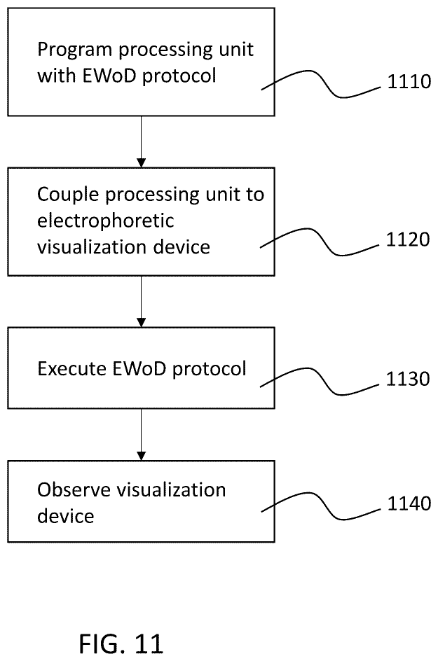

A generalized method of visualizing an EWoD pathing protocol with the visualization devices of the invention is shown in FIG. 11. In a first step 1110, an EWoD processing unit is provided that has been programmed with a pathing protocol, which may include droplet movement, magnetic actuation, and temperature control. In a second step 1120, the EWoD processing unit is coupled to an electrophoretic visualization device, i.e., visualization devices 700 and 800, discussed above. In a third step 1130, the pathing protocol is executed, and in a fourth step 1140, the performance of the pathing protocol is observed on the visualization device. Methods of the invention can include additional steps such as analyzing images of the visualization device, which may be time stamped, or modifying the pathing protocol based upon the results of the electrophoretic visualization test.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the fluid are not encapsulated within microcapsules but instead are retained within a plurality of cavities formed within a carrier medium, typically a polymeric film. Sec, for example, U.S. Pat. Nos. 6,672,921 and 6,788,449, in the name of SiPix Imaging, Inc., now in the name of E Ink California, Inc.

According to some embodiments, a particle-based display layer may include white and black pigment particles, black pigment particles may, in some states, be located toward the front of the display such that incident light is largely absorbed by the black particles. A magnetic field produced by an addressing magnet, e.g., a magnetic stylus, may change an optical state of the display such that the black particles clump, gather, or chain together thereby allowing the incident light to be reflected by the white particles underlying the black particles. The change in optical state may additionally include movement of the white and/or black particles within the display. Alternatively, a multi-pigment display may be configured to instead locate white pigment particles toward the front of the display such that incident light is largely reflected by the white particles. A magnetic field produced by a stylus may then change an optical state of the display such that more of the incident light is absorbed by the black particles. In such an embodiment, when black particles are moved toward the front of the display using a magnetic field, a dark gray state rather than an extreme black state occurs. Likewise, when white magneto-electrophoretic particles are moved towards the front of the display using a magnetic field, a light gray or white gray state occurs. Additional types of electrophoretic imaging media are known that include, e.g., three particles as described in U.S. Pat. No. 9,285,649, or four particles as described in U.S. Pat. Nos. 9,812,073 and 9,921,451. It has been observed that electrophoretic media that include more different types of particles are more sensitive to temperature changes and the visualization of, e.g., yellow versus blue at a viewing surface of the visualization device may be easier to distinguish than, e.g., differences in shades of black and white.

The particle-based electro-optic display may include one or more pigment types. In a multi-pigment display, at least one of the pigment types may be both electrically- and magnetically-controllable. An example of a multi-pigment display is a display including white pigment particles and black pigment particles. The black pigment particles may be both electrically and magnetically controllable, as an example. The black or the white pigments may be ferromagnetic or paramagnetic. Commercially-available magnetic particles, such as Bayferrox 8600, 8610; Northern Pigments 604, 608; Magnox 104, TMB-100; Columbian Mapico Black; Pfizer CX6368, and CB5600 and the like, may be used alone or in combination with other known pigments to create pigments that are both electrically and magnetically controllable. In general, magnetic particles having a magnetic susceptibility between 50-100, a coercivity between 40-120 Oersted (Oc), a saturation magnetization between 20-120 emu/g, and a remanence between 7-20 emu/g are preferred. Additionally, it may be beneficial for the particles to have diameters between 100-1000 nanometers (nm). As a specific, but non-limiting, example, the pigment of an electro-optic display in some embodiments may be a form of magnetite (Iron Oxide, such as Bayferrox 318M), neodymium oxide (such as Sigma Aldrich 634611 Neodymium (III) Oxide), iron and copper oxide (such as Sigma Aldrich Copper Ferrite), or an alloy of iron and cobalt or iron and nickel (such as Sigma Aldrich Iron-Nickel Alloy Powder and American Elements Iron-Cobalt Alloy Nanopowder).

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense. The functional aspects of the invention that are implemented on a processing unit, as will be understood from the teachings hereinabove, may be implemented or accomplished using any appropriate implementation environment or programming language, such as C, C++, Cobol, Pascal, Java, Java-Script, HTML, XML, dHTML, assembly or machine code programming, and the like. All of the contents of the aforementioned patents and applications are incorporated by reference herein in their entireties. In the event of any inconsistency between the content of this application and any of the patents and applications incorporated by reference herein, the content of this application shall control to the extent necessary to resolve such inconsistency.

1. A visualization device, comprising in order as viewed from above:
a light transmissive electrode layer;
an electrophoretic medium comprising charged particles that translate in response to an applied electric field, an applied magnetic field, or a change in temperature;
an adhesive layer;
a hydrophobic layer;
a dielectric layer; and
a substrate comprising a plurality of propulsion electrodes coupled to a set of thin-film-transistors, the propulsion electrodes being disposed on a side of the substrate toward the dielectric layer.

2. The visualization device of claim 1, additionally including a controller operatively coupled to the set of thin-film-transistors and configured to provide propulsion voltages to the thin-film transistors.

3. The visualization device of claim 1, wherein the hydrophobic layer and the dielectric layer are the same layer.

4. The visualization device of claim 1, wherein the electrophoretic medium is compartmentalized in microcapsules held in a binder layer or compartmentalized in microcells sealed with a sealing layer.

5. The visualization device of claim 1, wherein the electrophoretic medium comprises two types of charged particles that have different optical properties and opposite electrical charges.

6. The visualization device of claim 5, wherein one of the types of charged particles is ferromagnetic.

7. The visualization device of claim 6, wherein the ferromagnetic particles are black.

8. The visualization device of claim 1, wherein the charged particles are black in color.

9. A visualization cartridge including a visualization device of claim 1 and having a connector to allow the visualization cartridge to be connected to a digital microfluidic processing unit configured to drive an active matrix electrowetting on dielectric digital microfluidic (AM-EWOD-DMF) device.

10. A system for visualizing digital microfluidic pathing, comprising:
a digital microfluidic processing unit, including a processor and memory, and configured to provide instructions to an active matrix of propulsion electrodes to cause one or more aqueous droplets in a hydrophobic medium to move across the matrix of propulsion electrodes by changing the voltage provided to the respective propulsion electrodes as a function of time;
a visualization device comprising a light-transmissive electrode, an electrophoretic medium, and an active matrix of propulsion electrodes controlled by thin-film-transistors, the visualization device being coupled to the digital microfluidic processing unit and configured to receive the instructions; and
a camera to observe changes in the visualization device when the instructions are delivered from the digital microfluidic processing unit to the visualization device.

11. The system of claim 10, wherein the electrophoretic medium includes two types of electrically-charged particles having different optical states and opposite electric polarities.

12. The system of claim 11, wherein one of the types of electrically-charged particles is ferromagnetic.

13. The system of claim 12, further comprising a magnetic actuator, wherein the magnetic actuator is also operatively connected to the digital microfluidic processing unit.

14. The system of claim 10, further comprising a heating element, wherein the heating element is also operatively connected to the digital microfluidic processing unit.

15. The system of claim 10, wherein the visualization device comprises a dielectric layer between the electrophoretic medium and the active matrix of propulsion electrodes controlled by thin-film-transistors.

16. The system of claim 10, wherein the visualization device comprises a hydrophobic layer between the electrophoretic medium and the active matrix of propulsion electrodes controlled by thin-film-transistors.

17. A method for visualizing programmed pathing or magnetic actuation in a digital microfluidic device including an array of propulsion electrodes controlled by thin-film-transistors, the method comprising:
providing a digital microfluidic processing unit, including a processor and memory, and configured to provide instructions to an active matrix of propulsion electrodes to cause one or more aqueous droplets in a hydrophobic medium to move across the matrix of propulsion electrodes by changing the voltage provided to the respective propulsion electrodes as a function of time;
providing a visualization device comprising a light-transmissive electrode, an electrophoretic medium, and an active matrix of propulsion electrodes controlled by thin-film-transistors;
coupling the visualization device to the digital microfluidic processing unit;
executing instructions for an active matrix of propulsion electrodes to cause one or more aqueous droplets in a hydrophobic medium to move across the matrix of propulsion electrodes by changing the voltage provided to the respective propulsion electrodes as a function of time; and
visualizing a change in the visualization device.

18. The method of claim 17, wherein visualizing comprises observing optical changes in the electrophoretic medium.

19. The method of claim 18, wherein the electrophoretic medium includes two types of electrically-charged particles having different optical states and opposite electric polarities.

20. The method of claim 19, wherein one of the types of electrically-charged particles is ferromagnetic.

21. The method of claim 20, further comprising providing a magnetic actuator, wherein the magnetic actuator is also operatively connected to the digital microfluidic processing unit, and executing instructions for the magnetic actuator to move more proximate or less proximate to the visualization device.

22. The method of claim 17, further comprising providing a heating element, wherein the heating element is also operatively connected to the digital microfluidic processing unit, and executing instructions for the heating element to provide thermal energy to the visualization device.

23. The method of claim 17, further comprising providing a detector and aligning the detector to one or more propulsion electrodes.
